(19) United States
(12) Patent Application Publication
(10) Pub. No.: US 2017/0184434 A1
(43) Pub. Date: Jun. 29, 2017

(54) BREATHER TUBE INDICATOR

(71) Applicant: NCM INNOVATIONS (PTY) LTD, Johannesburg (ZA)

(72) Inventor: Brendan Robert CROMPTON, Johannesburg (ZA)

(21) Appl. No.: 15/309,537

(22) PCT Filed: May 15, 2015
(86) PCT No.: PCT/ZA2015/000035

§ 371 Date: Nov. 8, 2016

(30) Foreign Application Priority Data
May 15, 2014 (ZA) 2014/02855

(51) Int. Cl. G01F 11/02; E21D 20/02; E21D 21/00

(52) U.S. Cl. CPC G01F 11/025; E21D 21/0093; E21D 20/02

(57) ABSTRACT

The invention provides a breather tube indicator device which includes a sealing body which is adapted to fit within a breather tube of a grouted rock support installation to allow passage of air past the body, without the body moving relatively to the tube, but to resist passage of an adhesive material thereby to cause movement of the body relatively to the tube to an indicating position.

### FIELD OF THE INVENTION

The invention relates to an indicator device which, when engaged with a grout breather pipe of a rock bolt installation, is adapted to indicate when sufficient grout has been delivered into a rock hole to fill a volume of the rock hole.

### BACKGROUND OF THE INVENTION

In a rock bolt installation, at the mouth of a rock hole into which a grouted rock bolt is installed, a grout tube passes into the rock hole, typically through a seal seating the mouth from grout egress, through which grout is introduced into the rock hole, and a breather tube passes from the rock hole, through which air, displaced by the incoming grout, flows from the rock hole.

As an indication of when the rock hole has been fully grouted, a worker relies on the presence of grout at the mouth of the breather pipe. However, some workers have placed globs of the grout at the mouth, in an attempt to bypass the time and effort of fully grouting the rock holes. A supervisor will then be fooled into thinking that the particular installation has been fully grouted and pass by. The danger of this practice is a rock bolt that has not been grouted in the rock hole, fully or at all.

Furthermore, the passage of grout out of the breather tube poses a potential risk to persons below inspecting the installation as the grout can fall from the tube into the person's eye, potentially damaging his eyes.

The invention at least partially addresses the aforementioned problems.

### SUMMARY OF THE INVENTION

Hereinafter, reference to “a grouted rock support installation” refers to an installation or system used to support a rock or soil face of a civil or mine working which system includes a rock bolt anchor a tendon which is secured within a hole formed into the face by an adhesive such as a resin or grout.

The invention provides a breather tube indicator device which includes a sealing body which is adapted to fit within a breather tube of a grouted rock support installation to allow passage of air past the body, without the body moving relatively to the tube, but to resist passage of an adhesive material thereby to cause movement of the body relatively to the tube to an indicating position.

In the indicating position, the sealing body provides a visual indication of the attainment of particular level of grouting within a rock hole.

The device may include a projecting element that is engaged, or integrally formed, with the body to at least partially project from an outlet end of the breather tube when the body is in the indicating position.

The projecting element may be an integrally formed stem or filament. Alternatively, the projecting element may be a filament of, for example wire or plastic, engaged with the body.

The body may have an axial bore.

The axial bore may be sized to resist passage of the adhesive material and yet allows passage of air.

Alternatively, the body may include a barrier element, of a porous material, which is interposed in the bore to allow passage of air and to resist passage of the adhesive material.

Alternatively the body may have one or more longitudinally aligned channels formed in an outer surface of the body. Each of these channels may provide a passage to air and yet resist passage of the adhesive material.

The device may include a tubular housing in which the sealing body at least partially locates.

The tubular housing may be sealingly and fixedly engaged with the outlet end of the breather tube.

The housing may sealingly and fixedly engage with the outlet end of the breather tube by being sized to frictionally fit within the tube.

The tubular housing may be fixed within the tube by adherence with a suitable adhesive.

### BRIEF DESCRIPTION OF THE DRAWINGS

The invention is now described by way of non-limiting examples only with reference the drawings in which:

FIG. 1 diagrammatically illustrates a rock bolt installation in a rock hole, using a bung to seal a mouth of the rock hole and through which the rock bolt passes a grout pipe and a breather pipe;

FIG. 2 illustrates, in longitudinal section, a breather tube indicator device in accordance with a first embodiment of the invention, inset into an outer end of the breather pipe;

FIGS. 3 and 4 illustrate, in longitudinal section, a breather tube indicator device in accordance with a second embodiment of the invention, in a first position and a second indicating position respectively;

FIGS. 5 and 6 illustrate, in longitudinal section, a breathes tube indicator device in accordance with a third embodiment of the invention, in a first position and a second indicating position respectively;

FIGS. 7 and 8 illustrate, in longitudinal section, a breather tube indicator device in accordance with a fourth embodiment of the invention, in a first and a second indicating position respectively;

FIG. 9 illustrates a view in cross-section, through line 9-9 of FIG. 7; and

FIGS. 10 and 11 illustrate, in cross section and in perspective respectively, an indicator member of another embodiment.

### DETAILED DESCRIPTION OF THE ILLUSTRATED EMBODIMENTS

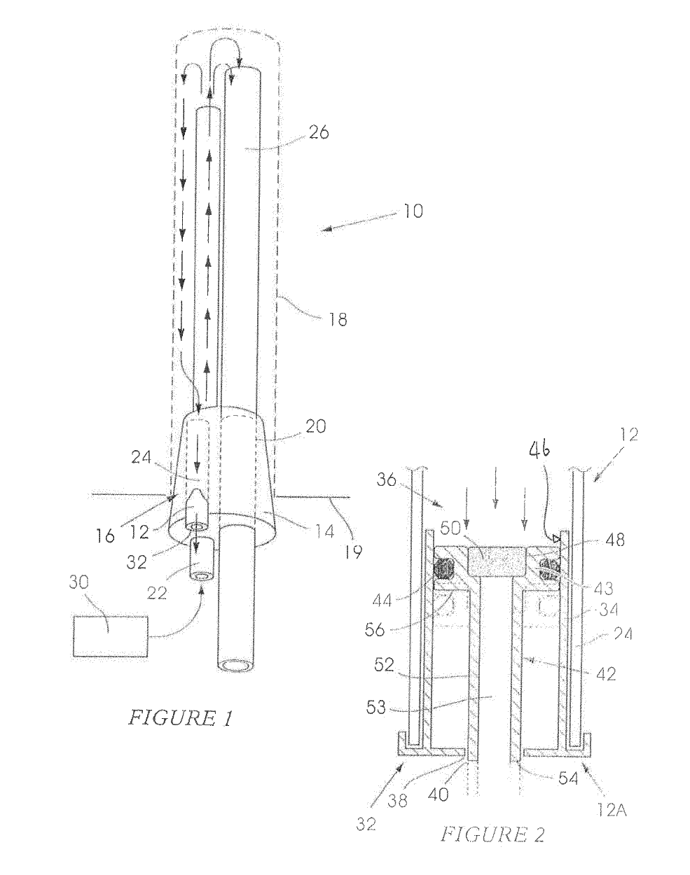

FIG. 1 illustrates a rock bolt installation 10 into which is incorporated a breather tube indicator device 12 in accordance with anyone of the embodiments of the invention which are respectively illustrated in FIG. 2, 3, 1 and 5.

The installation 10 includes a bung 14 which seals a mouth 16 of a rock hole 18, in hanging wall 19 and through which passes a rock bolt conduit 20, a grout pipe 22 and a breather tube 24. A rock bolt 26 is inserted into the conduit 20 to pass through the bung 14 as illustrated.

It must be understood that this example is not limiting on the invention and that the grout pipe 22 and breather tube 24 do not have to pass through or be incorporated in a bung 14. The pipe 22 and the tube 24 can pass through any seal or device, for example a face plate, which seal or blocks the mouth of the rock hole 18.

A grout or adhesive material, from a source 30, is pumped through the grout pipe 22 into the rock hose 18 and flows, as diagrammatically represented by a series of directional arrows in FIG. 1, into an annular space between the rock bolt and the walls of the rock hole. The grout input progressively fills this annular space, displacing air through the breather tube 24 as it does so. When the grout has substantially filled the rock hole 18, and with nowhere else to flow, the grout will pass through the breather tube 24 and eventual flow out at an outer end 32 of the breather tube 24; that is in the absence of the indicator device 12.

The indicator device 12, of any of the embodiments, can be sealingly and resiliently frictionally inset into the outer end 32 of the breather tube 24 to prevent the device 12 from being pushed from the breather tube 24 by the force of the outflowing grout. Alternatively, the indicator device 12 can be secured in the breather tube 24 with an adhesive.

In a first embodiment, illustrated in FIG. 2, the indicator device 12A has a hollow tubular body 34 with an open end 38 and an opposed closed outer end 38, through which passes an aperture 40. Within the tubular body 34, an indicator member 42 is reciprocally engaged.

The indicator member 42 has a main body part 43 which is substantially complementarily dimensioned to the circumference of a tubular interior of the body 34 which carries an O ring seal 44 to provide sealing engagement of the part 43 with the interior walls 46 of the tubular interior.

Within a disc shaped recess 48, at an interior side of the body part 43, a filter barrier 50, of a porous medium, is inset. The porous material can be a glaze material or a sintered sieve.

Axially projecting from the body part 43, at an opposed side, is an indicator stem 52 which extends to the aperture 40 in a first position, as illustrated in FIG. 2 in solid outline. The radius of the stem 52 is such that it fits snugly within the aperture 40. In the first position, a projecting end 54 is recessed below the plane of the closed end 38.

The member 42 has a passage 53 that opens at a base of the recess 48 and which passes from the body part 43, through the stem 52, to the projecting end 54.

When grout starts to fill the rock hole 18, air passage through the breather tube 24 through the passage 53 of the member 42 and out through an opening at the projecting end 54 of the stem is unhindered as the pores of the porous material of the filter 50 are larger than the air molecules. The filter 50 is therefore permeable to the passage of the air.

However, when the grout passes into the breather tube 24, when the rock hole 18 has become substantially fully grouted, the flow of grout is stopped and backed-up at an interior side of the body part 43 of the member 42. The grout is unable to pass through the filter 50 as the pores of the porous material are smaller than the grout particles.

The pressure (illustrated by directional arrows in FIG. 2) of this grout back-up will force the indicator member 42 to move towards the closed end 38 of the body, into a second limited position (at which position a shoulder 56 of the body part 43 abuts an inner surface of the closed end 38), at which position the projecting end 54 of the indicator stem 52 projects fully from the closed end 38, through the aperture 40, as a visual indication that the rock hole 18 is fully grouted. Movement of the indicator member 42 towards the second position is illustrated on FIG. 2 with a displaced member in dotted outline.

The indicator stem 52 can be brightly coloured to improve its visual impact.

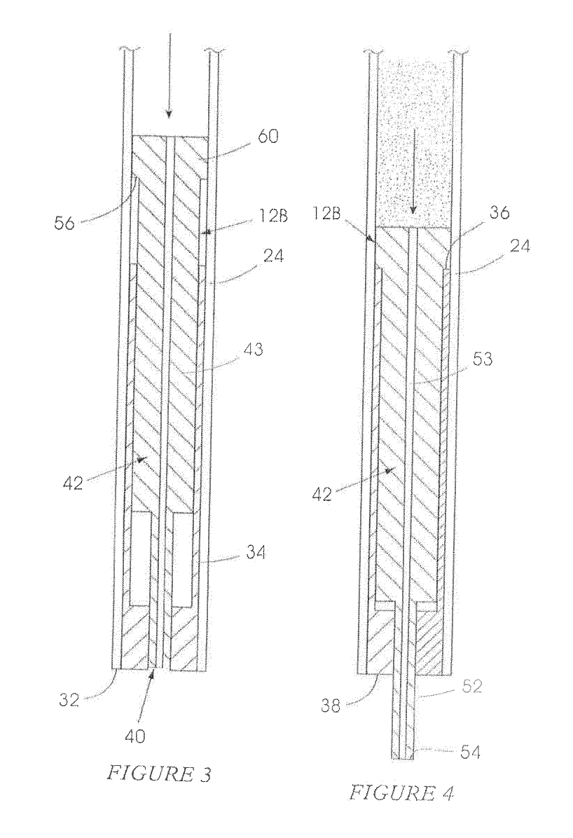

A second embodiment of the indicator member 12B is illustrated in FIGS. 3 and 4. When describing this embodiment, and the embodiment that follows, like features bear like designations.

The indicator member 42 is only partially inserted into the tubular sleeve 34. The indicator member does not carry a seal like its counterpart (device 12A) but, instead, is sealingly frictionally engaged with the inner walls of the tubular body.

The passage 53 of the indicator member 42 is a narrow bore, diametrically significantly smaller than the passage 53 of the member to counterpart device 12A. The passage is sized such that free flow of air through the passage is allowed and yet the passage is resistive to the flow of the particulate grout. This feature of the narrow bore passage is functionally analogous to the filter barrier 50 of the prior embodiment, in that flow of grout is essentially stopped at or towards an interior side of a head portion 60 or the main body part 43 thus resulting in pressure build which will force the member 42 to move from the first position, illustrated in FIG. 3, to a second position, illustrated in FIG. 4.

The second position is limited, in this embodiment, by abutment of a shoulder 56, undercutting the head portion 60, with end 36 of the tubular body 34.

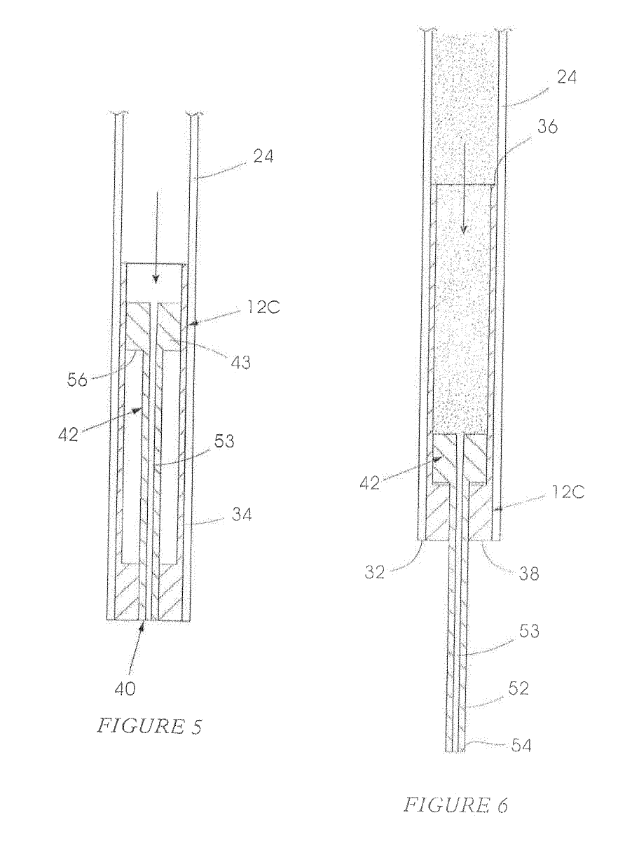

A third embodiment of the indicator device 12C is illustrated in FIGS. 5 and 6.

Like the earlier embodiment of device 12B, indicator device 12C is internally adapted, to allow air to pass through the indicator member 42 without moving from a first position (illustrated in FIG. 5) but is resistive to passage of grout, by the inclusion, axially through the member 42, of the narrow bore passage 53.

The indicator member 42 is wholly located within the tubular sleeve 34 to move from the first position, to a second limited position, illustrated in FIG. 6, by abutment or a shoulder 56, undercutting the main body part 43, against an inner surface of the closed end 38 of the sleeve 34.

In the second, limited, positions of indicator devices 12B and 12C, respective indicator stems 52 project from the respective closed ends 38 as a visual indication of full column grouting being achieved.

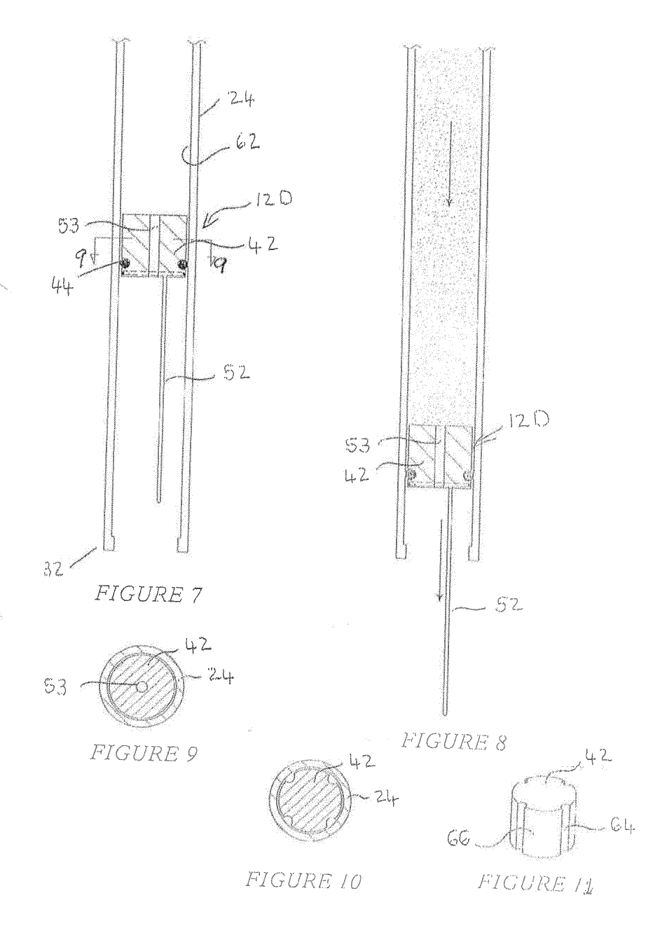

A fourth embodiment is illustrated in FIGS. 7 to 9. This embodiment of the indicator device 12D substantively differs from earlier described embodiments in that the indicator member 42 is not housed within a sleeve 34 which is then inserted within breather tube 24. Rather, the indicator member directly engaged within the tube 24.

The member 42 carries seal 44, to provide sealing engagement of the member with the interior walls 62 of the breather tube, and has a narrow bore passage 53.

The member 42 includes a wire filament 52 which is analogous to the indicator stems of previous embodiments. At one end, the wire filament is wound around the body of the member 42 to engage with the member. From the point of attachment, the remainder of the filament extends in an axial direction within the lumen of the breather pipe 24, towards the outer end 32 of the pipe.

As with embodiments of the device (12B and 12C), the narrow bore passage is sized to allow air to flow from an interior to an exterior end of the member 42 whilst resistive to the flow of grout therethrough.

FIG. 7 illustrates the member 42 in a first position, located high up within the breather tube such that no part of the wire filament 52 projects from the end 32 of the pipe 24. When grout starts to flow into the breather pipe, as illustrated in FIG. 8, pressure build up on an inside of the member, due to its impermeability, will cause the member to move within the tube towards the outer end and to a ground position.

In the second position, the wire filament 52 projects from the tube as an indication of the achievement of fill column grout.

In a varying on the embodiment 12D, the indicator member 42 can have a plurality of radially spaced axially aligned channels 64 formed on an outer surface 66 of the member.

When the member 42 is engaged within the breathe pipe 24, the inner wall 62 of the pipe and the channels 64 provide conduits that are functionally analogous to the bore passage 53 in that they facilitate air to bypass the member but are diametrically too small to allow for grout to pass through.

The indicator device 12D distinguished over the earlier embodiments is that it is adapted to be received deep with the breather tube. This is not the case with devices 12A, 128 and 12C, each of which is engaged to, or just within the outlet end 32 of the tube 24. The advantage of this “deep” positioning of indicator device 12D is that it is likely to remain intact during blasting in the excavation in which the rock bolt installation 10 is located, protected within the rock hole. The outer device embodiments are located outside of the hole, on the tube's exposed outlet end 32, and are often torn from the breather tube by high velocity debris caused by blasting.

What is claimed is:

1. A breather tube indicator device which includes a sealing body which is adapted to fit within a breather tube of a grouted rock support installation to allow passage of air past the body, without the body moving relatively to the tube, but to resist passage of an adhesive material which causes movement of the body, relatively to the tube, to an indicating position.

2. The breather tube indicator device according to claim 1 wherein, in the indicating position, the sealing body provides a visual indication.

3. The breather tube indicator device according to claim 1 wherein the device includes a projecting element that is engaged, or integrally formed, with the body to at least partially project from an outlet end of the breather tube when the body is in the indicating position.

4. The breather tube indicator device according to claim 3 wherein the projecting element is an integrally formed stem.

5. The breather tube indicator device according to claim 3 wherein the projecting element is a filament of wire or plastic, engaged with the body.

6. The breather tube indicator device according to claim 1 wherein the body has an axial bore.

7. The breather tube indicator device according to claim 6 wherein the axial bore is sized to resist passage of the adhesive material and yet allows passage of air.

8. The breather tube indicator device according to claim 6 wherein the body includes a barrier element, of a porous material, which is interposed in the bore to allow passage of air and to resist passage of the adhesive material.

9. The breather tube indicator device according to claim 1 wherein the body has one or more longitudinally aligned channels formed in an outer surface of the body, each of these channels providing a passage to air and yet resist passage of the adhesive material.

10. The breather tube indicator device according to claim 1 wherein the device includes a tubular housing in which the sealing body at least partially locates.

11. The breather indicator device according to claim 10 wherein the tubular housing is sealingly and fixedly engaged with the breather tube.

12. The breather indicator device according to claim 11 wherein the housing is sized to frictionally fit within the tube.
